(19) United States
(12) Patent Application Publication
(10) Pub. No.: US 2024/0230937 A1
(43) Pub. Date: Jul. 11, 2024

(54) SYSTEM AND METHOD FOR SEISMIC DATA ACQUISITION USING SEISMIC DRONES

(71) Applicant: SAUDI ARABIAN OIL COMPANY, Dhahran (SA)

(72) Inventors: Grigoriy Yashin, Moscow (RU); Pavel Golikov, Moscow (RU); Mustafa N. AlAli, Moscow (RU); Marwan Charara, Moscow (RU)

(73) Assignee: Aramco Innovations LLC, Moscow (RU)

(21) Appl. No.: 18/001,069

(22) PCT Filed: Jan. 28, 2022
(86) PCT No.: PCT/RU2022/000023

§ 371 Date: Dec. 7, 2022

(51) Int. Cl. G01V 1/24; B64U 20/83; B64U 20/87; B64U 70/90; B64U 101/35; G01S 19/51; G01V 1/16; G01V 1/22

(52) U.S. Cl. CPC G01V 1/247; B64U 20/83; B64U 20/87; B64U 70/90; G01S 19/51; G01V 1/162; G01V 1/22; B64U 2101/35

(57) ABSTRACT

A seismic drone, a system including a plurality of seismic drones and a base station, and a method of use of the system is disclosed. The seismic drone includes a positioning device, surveillance system, telecommunications transceiver, electronic control system (including a microprocessor), adaptable landing gear, a seismic receiver deployment system, and a seismic data recording system. The seismic drone is capable of take-off, flight to a target location (or locations), landing at the target location, deploying a seismic receiver, and sending data back to a base station or master drone.

### BACKGROUND

Drones may be used in consumer and professional activities such as aerial photography, cartography, inspection of industrial objects, military operations. Among these applications, it can be highlighted that the drone payload is mainly represented by optical sensors, e.g., conventional or multispectral cameras. Drones can also be effectively exploited for heavier industrial purposes such as land seismic data acquisition.

Currently, large manual work forces are used in seismic data acquisition. The work force, among other activities, engages in placing a network of seismic sensors (e.g., ˜100 000 seismic receivers) over the seismic study area (e.g., several hundreds of square kilometers) as well as moving and maintaining the seismic sensors throughout the duration of the seismic survey. Thus, the usage of a plurality of drones equipped with seismic sensors is an economical and efficient solution that ensures autonomous continuous seismic survey with minimum human involvement.

This seismic drone system requires the development of a seismic drone with the capability to land on uneven surface (including inclined surfaces and surfaces with obstacles), to maintain reliable acoustic contact between the sensor and the ground, to collect or/and transfer acquired data (e.g., recorded seismic signals, global coordinates, and GPS time) to the base station which may include the control unit or server. The mobility and flexibility of a plurality of drones provide a wide range of acquisitions scenarios with various sensor spacing and spatial distribution. The examples of such application may include, but are not limited to, near-surface characterization where a relatively small but dense receiver array is required to record well-sampled signal.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein describe a seismic drone including a positioning device, surveillance system, telecommunications transceiver, electronic control system (including a microprocessor), adaptable landing gear, a seismic receiver deployment system, and a seismic data recording system.

In general, in one aspect, embodiments disclosed herein describe a system made up of a plurality of seismic drones, each having a seismic receiver, and a base station in telecommunication with each of the plurality of seismic drones.

In general, in one aspect, embodiments disclosed herein describe a method of deploying a plurality of seismic drones, each having a seismic receiver and a microprocessor, by transmitting, from a base station to each of the plurality of seismic drones, instructions executable by the microprocessor of each seismic drone. The instructions provide commands to each seismic drone for taking off from an initial location carrying the seismic receiver; flying to a first target location, surveilling a first landing zone around the first target location, landing within the first landing zone, coupling the seismic receiver to a first ground surface, and recording seismic data. The method further includes decoupling the seismic receiver from the first ground surface, taking off from the first landing zone carrying the seismic receiver; flying to a final location (or a second location), and landing at the final location (or the second location).

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a generalized seismic acquisition system in accordance with one or more embodiments.

FIG. 2 depicts a seismic receiver in accordance with one or more embodiments.

FIG. 3 depicts a seismic drone in accordance with one or more embodiments.

FIG. 4 depicts a seismic drone control system in accordance with one or more embodiments.

FIG. 5 depicts a seismic data acquisition system utilizing a plurality of seismic drones in accordance with one or more embodiments.

FIG. 6 depicts a flowchart describing a methodology of deploying seismic receivers using a plurality of drones in accordance with one or more embodiments.

### DETAILED DESCRIPTION

In the following detailed description of embodiments of the disclosure, numerous specific details are set forth to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

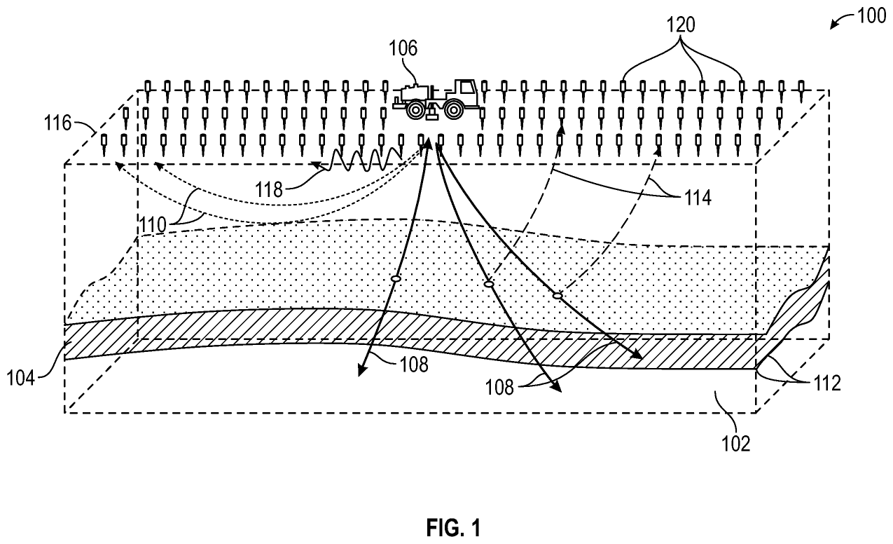

In the following description of FIGS. 1-6, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Seismic data acquisition is frequently burdened by issues of safety exposure, access, and operational inefficiencies that increase cost or preclude continuous seismic coverage. For example, mountainous areas or solid ground within swamps or river deltas are notoriously hard to reach with seismic receivers. Many of these issues can be reduced or resolved by an aerial delivery and deployment system for seismic receivers, i.e., seismic drones. Embodiments are disclosed describing apparatus, systems, and methodology that may enable safer, more continuous, more efficient, and cost-effective seismic data acquisition.

FIG. 1 shows a seismic survey (100) of a subterranean region of interest (102), which may contain a reservoir (104). The seismic survey (100) may utilize a seismic source (106) that generates radiated seismic waves (108). In a land environment, the seismic source (106) may be a dynamite source or one or more seismic vibrator (“vibroseis truck”). In a marine or lacustrine environment, the seismic source (106) may be an air gun. The radiated seismic waves may be recorded by a plurality of seismic receivers (120). A single activation of the seismic source (106) may be recorded by tens or hundreds of thousands of seismic receivers (120). Typically, in a land environment the seismic receiver (120) may record the velocity or acceleration of ground-motion, while in a marine or lacustrine environment the seismic receiver (120) may record pressure fluctuations caused by the seismic waves (108).

The radiated seismic waves (108) may propagate along the ground surface (116) as surface waves (“ground-roll”) (118), or the radiated seismic waves (108) may propagate below the surface and return as refracted seismic waves (110) or may be reflected one or more times by geological discontinuities (112) and return to the surface as reflected seismic waves (114).

A seismic dataset may be processed to produce valuable information, such as one or more seismic images or one or more seismic attributes. Typically, a seismic processing workflow addresses a sequence of steps including noise attenuation, acquisition regularization, multiple identification and attenuation, seismic wave propagation velocity determination, seismic imaging, and seismic attribute determination. Several of these steps, such as seismic imaging and seismic attribute determination, require further interpretation to identify the locations within the subsurface at which hydrocarbon accumulations may be present. In some embodiments, the interpretation may occur after the generation of the post-stack seismic image or the seismic attribute. In other embodiments, the interpretation may be performed in parallel or interleaved or integrated into the process of determining the post-stack seismic image or the seismic attribute.

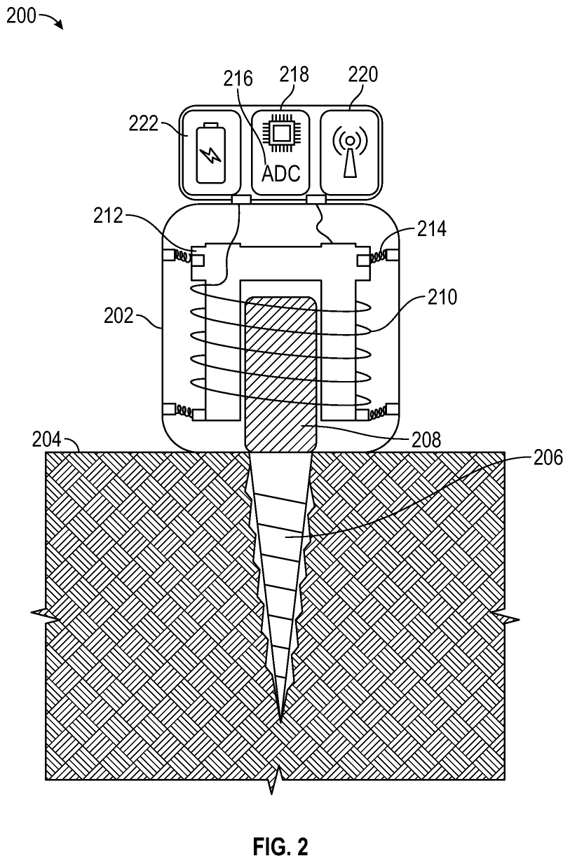

In accordance with one or more embodiments, a seismic receiver (200) may consist of a geophone as shown in FIG. 2. In other embodiments a seismic receiver may consist of a geophone, accelerometer, hydrophone, or a strain meter sensor individually, in multiple, or in combination. The sensor may be housed in a sensor casing (202) which may have an arbitrary shape such as spherical, cylindrical, pyramidal, or cubic. The seismic receiver may be coupled to the ground surface (204) through a variety of coupling mechanisms such as a threaded ground spike (206), unthreaded ground spike (not shown), or weighted base plate (not shown). A permanent magnet (208) may be attached to the coupling mechanism and disposed inside a coil (210) of conductive wire wound around a reaction mass (212). The reaction mass may be connected to the sensor casing (202) by at least one spring (214) such that the coil (210) and reaction mass (212) may oscillate with respect to the permanent magnet (208) in response to an applied vibration. The oscillation may induce a voltage in the conductive wire of the coil (210). The induced voltage may be digitized using an analogue-to-digital converter (ADC) (216) and the resulting time series, or digitized seismic trace, may be stored within the seismic receiver (200) in a microprocessor and memory module (218). As an alternative, or in addition, the time series may be transmitted to a remote receiver using a telecommunications transceiver (220) or electrical communication cables (not shown).

A seismic receiver (200) may also contain ancillary components such as a battery (222). In addition, the telecommunications transceiver (220) may send and receive diagnostic information, and status indicators such as battery life, memory capacity.

In accordance with other embodiments, any or all of the ADC (216), the microprocessor and memory module (218), the telecommunications transceiver (220), and the battery (222) may be provided from the seismic drone without departing from the scope of the invention.

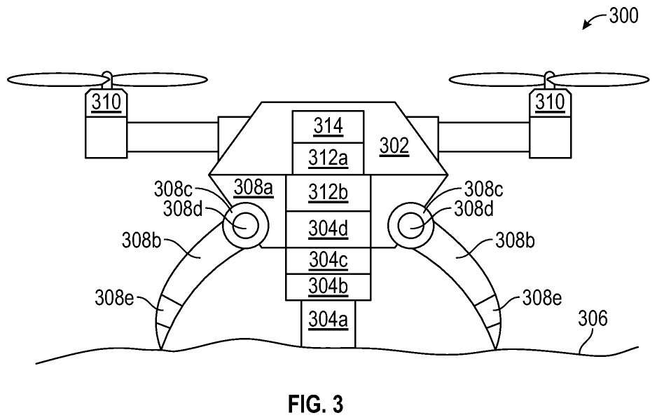

FIG. 3 depicts a configuration of a seismic drone (300) which may be utilized in seismic data acquisition activities such as seismic data recording or seismic survey area reconnaissance. To carry out these functions the seismic drone (300) may have the capacity to receive instructions, navigate via flight to a target location, position at a target location, perform surveillance, assess a target location's suitability for landing and deploying the seismic receiver, land on the surface, deploy and retrieve the seismic receiver, and transmit and receive data.

In accordance with one or more embodiments, the seismic drone body (302) may have any shape (e.g., polygonal, spherical, etc.) with protruding elements (e.g., beams) for mounting components such as motors. The seismic drone (300) may be manufactured using different materials (e.g., plastic, carbon, composite, metal, etc. or combination of these materials) with the purpose to protect the seismic drone from the environment.

In accordance with one or more embodiments, a seismic drone (300) may consist of a seismic receiver deployment system wherein each seismic drone (300) may carry a seismic receiver (304a) (or plurality or seismic receivers) embedded or detachably connected to the seismic drone body (302) to the target location and after landing couple the seismic receiver (304a) to the ground surface (306). Each seismic receiver (304a) may be coupled to the ground using a threaded spike and detached from the seismic receiver deployment system (304a-b) by the seismic-drone-to-seismic-receiver linkage (304b) which may consist of a passive mechanical joint with one or more springs and/or one or more rotation and/or translation degrees of freedom or a detachable mechanical joint such as a bolt that can be threaded and unthreaded. In other embodiments the seismic receiver (304a) may be coupled to the ground by other means such as a weighted base plate or by the weight of the seismic drone (300) which may contain a separate mechanism (e.g., spring or rubber membrane) in the seismic-drone-to-seismic-receiver linkage (304b) to effectively detach the seismic drone (300) from the seismic receiver (304a).

The seismic receiver deployment system (304a-b) may consist of actuating devices (304c) (e.g., servomotor, pneumatic device, etc.), and one or more feedback sensors (304d) (e.g., inertial, optical, and/or resistive sensor) that may enable the seismic-drone-to-seismic-receiver linkage (304b) to manipulate (e.g., push, pull, turn) the seismic receiver (304a) and receive data (e.g., up-force, down-force, torque, verticality, etc.) regarding the seismic receiver deployment.

In accordance with one or more embodiments, the seismic drone (300) may contain a landing gear (308a-e). The landing gear (308a-e) may allow the seismic drone (300) to land on the ground surface (306). Additionally, the landing gear (308a-e) may enable the seismic drone (300) to change an angle or orientation between the seismic drone body (302) and the ground surface (306) to adapt to the shape of the ground surface (306). Adaptive seismic drone landing may also prevent a possible crash of the seismic drone (300) during the landing procedure on uneven ground surfaces (306).

The landing gear (308a-e) may consist of a leg base (308a) connected to two or more legs (308b) through an adjustable joint (308c) that may consist of servomotors or passive rotational adjustable joints (308c) and embedded sensors (308d) such as inertial, optical, or resistive sensors that enable and track leg movement.

In another embodiment, the landing gear (308a-e) may be directly mechanically connected to the seismic drone body (302). Additionally, the landing gear (308a-e) may contain dampers (308e) (e.g., rubber, springs, or pneumatic devices) to damp the possible vibration of the seismic drone (300).

In accordance with one or more embodiments, the legs (308b) may extend from the leg base (308a) of the drone (300) at an angle of extension with respect to the vertical. In other embodiments of the landing gear (308a-e) the legs (308b) may include additional leg joints and devices to add additional functionality such as providing accelerated takeoff or providing jumping or walking ability once landed.

In accordance with one or more embodiments, the seismic drone (300) may consist of a propulsion system (310) which may consist of two or more motors with propellers that may enable the seismic drone (300) to take off, fly, hover, and land.

In accordance with one or more embodiments, the seismic drone (300) may consist of a power supply system that provides power to all the systems and devices of the seismic drone (300). The power supply system may consist of a power supply board (312a) and a battery (312b).

In accordance with one or more embodiments, the seismic drone (300) may consist of an electronic seismic drone control system (314).

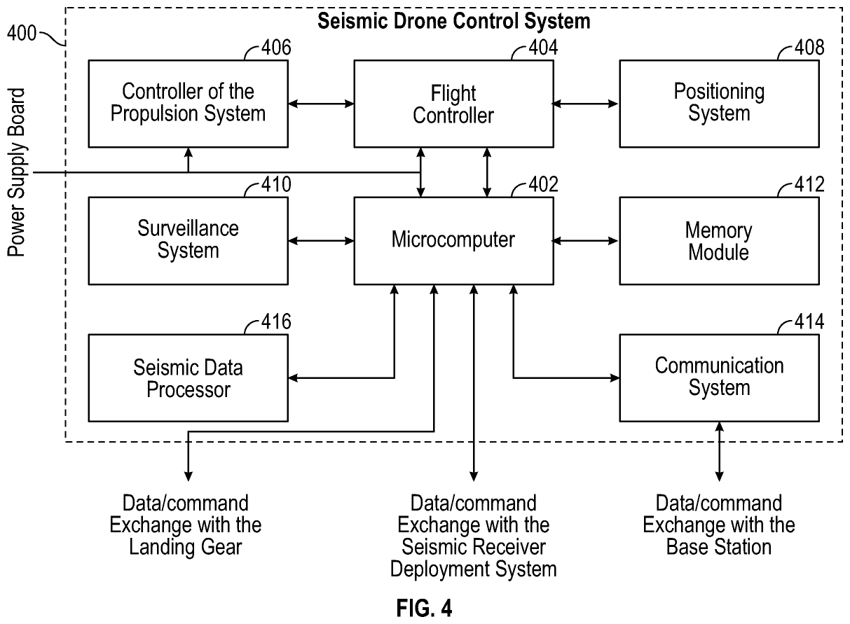

FIG. 4 depicts the electronic seismic drone control system (400) which may consist of a microcomputer (402) connected with a flight controller (404), a propulsion control system (406), a positioning system (408), a surveillance system (410), a memory module (412), a telecommunication system (414), and a seismic data processing system (416). The power supply system provides power to the seismic drone control system (400).

In accordance with one or more embodiments, the microcomputer (402) transmits and receives data between all the systems and components on the seismic drone and with the base station, other seismic drones, or any other receiver such as secondary or remote base station, seismic source vehicle, etc. The flight controller (404) is connected to one or more controllers of the propulsion control system (406) and positioning system (408) (e.g., GPS) and to the microcomputer (402). The microcomputer (402) also sends, receives, and processes data to and from the surveillance system to control the landing gear and seismic receiver deployment system.

In accordance with one or more embodiments, the telecommunication system (414) (e.g., using radio, Wi-Fi, or satellite link) through the microprocessor (402) may provide remote data/command exchange with a base station. These data/command exchanges may include the mission scenario (instructions for the seismic drone including location information), digital seismic data, seismic processing information, processed seismic data, seismic drone diagnostics such as battery power, memory storage statistics, flight statistics, sensor data, data gathered by the surveillance system or any other data a person of ordinary skill in the art may recognize. The telecommunication system (414) may transmit/receive data in real-time or on-demand, e.g. when it is near the base station or in the vicinity of reliable radio signal.

In accordance with one or more embodiments, the flight controller (404) communicates with the microcomputer (402) to get high-level commands (e.g., coordinates, take-off times, landing instructions, etc.) in accordance with the mission scenario stored in the memory of the microcomputer (402). According to these commands, the flight controller (404) manages the operation of one or more controllers of the propulsion system (406). The flight controller (404) receives the global coordinates from the positioning system (408) and transmits these data to the microcomputer (402).

In accordance with one or more embodiments, the surveillance system (410) uses one or more sensors (e.g., a cameras, a stereoscopic camera, a lidar, a radar, and/or an ultrasound transducer) which may be embedded into the seismic drone body (302) to recognize the landing zone for the seismic drone to check the possibility of the landing, seismic receiver installation, and the reliable seismic data recording. The microcomputer (402) may use computer vision algorithms and processes the data from the sensors of the surveillance system (410). The microcomputer (402) then sends necessary commands (e.g., land, move to an alternate location within the landing zone) to the flight controller (404). If the landing zone is viable for the landing and seismic receiver installation, the microcomputer (402) sends necessary commands to the landing gear and seismic receiver deployment system following the mission scenario. A viable landing zone may include one that is reachable by the drone physically and within range of the telecommunications system as well as having suitable characteristics (e.g., the absence of vegetation, water, and other potential obstacles). The microcomputer (402) may contain in its memory necessary algorithms to control landing gear for stably landing on the different uneven surface using the surveillance system (410) and the leg sensors. During the seismic survey, the seismic receiver may transmit collected data to the microcomputer (402), which records these data to the memory module (412).

In accordance with one or more embodiments, the memory module (412) may also be used for storing acquired data from other seismic drone sensors, such as sensors of the landing gear, feedback sensor of the seismic deployment system, the positioning system (408), and surveillance system (410) and seismic data processing system (416).

In accordance with one or more embodiments, the seismic data processing system (416), in some implementation, may receive data from the seismic receiver after analogue-to-digital conversion, raw (i.e., without any further processing after analogue-to-digital conversion), or processed (e.g., with applied recording filters or gains, noise attenuation processing, stacking, or any other process applied). In another implementation some or all the desired processes may occur within the seismic receiver. The seismic data processing system (416) may retain and write both raw and processed seismic data to memory.

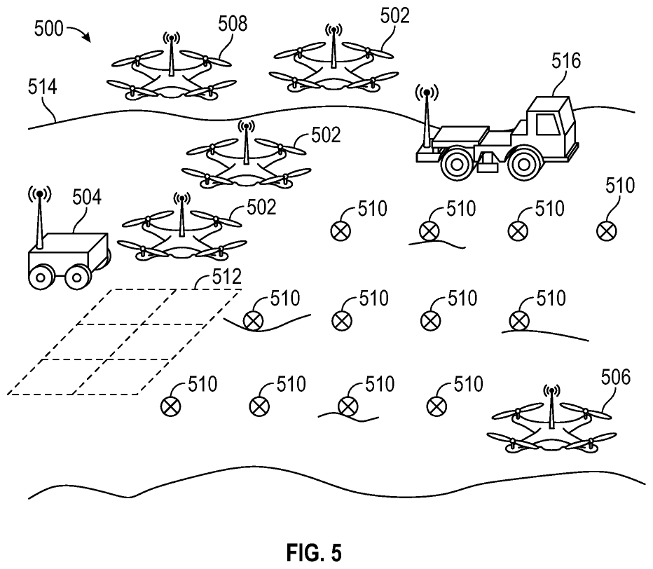

FIG. 5. depicts a seismic done survey system (500) using a plurality of seismic drones (502). A plurality of seismic drones (502) may be wirelessly connected to a base station (504) with an installed graphical or terminal user interface (UI). Using the UI the operator can perform reconnaissance of the area of interest using a scout seismic drone (506). In another implementation a seismic drone may be assigned to act as a master seismic drone (508) which may perform tasks other seismic drones are not assigned (e.g., scouting, data collection from other drones, seismic data processing, surveillance system processing, etc.). A mission plan may be developed based on data received from the scout seismic drone (506) or other information (e.g., topological maps, satellite photography, seismic acquisition design plans, etc.). The mission plan may establish seismic receiver target locations (510) and other pertinent information (e.g., possible base station locations, equipment storage areas, equipment staging areas, seismic acquisition sequence, etc.). From the mission plan, mission scenarios may be developed for each seismic receiver target location (510) which may be transmitted to seismic drones (502) as mission scenarios that may include seismic receiver target locations and any other pertinent information for the seismic drone (502) to carry out the mission scenario.

After uploading the mission scenario from the base station (504) or master seismic drone (508), the seismic drones (502) may take-off, individually or in plurality, from an initial position (512), navigate by flight to the assigned seismic receiver target location (510) and land on the surface (514) which may be uneven or irregular. The seismic drones (502) record seismic signal generated by the seismic signal source (516) (e.g., vibroseis truck, or other seismic sources). The seismic receiver may record continuously or may be programmed to turn on or off at a time defined by the mission scenario or received from the base station (504) or master seismic drone (508). The seismic drones (502) may simultaneously record other ancillary data associated with the mission scenario and from all onboard sensors and devices (e.g., weather, GPS data, sensor data from onboard systems such as surveillance system, data processing system, etc.).

The base station (504) may receive and display seismic and other data from one or more of the seismic drones (502) or seismic signal sources (516), launch additional seismic drones (502) (e.g., in the event a seismic drone is unable to reach the seismic receiver target location), record data to memory, produce seismic records, produce survey statistics, perform quality control functions (e.g., pre- and post-plot position information), assign geometries, analyze seismic drone diagnostic data, etc.). The base station (504) may also provide data processing functionality to assess seismic data (and ancillary) data (e.g., first break picking, velocity analysis, filtering, noise attenuation algorithms, stacking, and migration). In another implementation, some or all these processes may be carried out onboard the master seismic drone (508) or on another seismic drone (502).

Real-time wireless data (e.g., seismic data) collection from the seismic drones (502) may be realized using a master seismic drone (508) operated near groups of other seismic drones (e.g., master seismic drone (508) navigation within range of other seismic drones) or through antennas or antenna arrays to provide reliable communication on the large exploration area (e.g., several square kilometers).

For any seismic data acquisition, the number of seismic drones (502) and master seismic drones (508), and the distance between seismic drones may be in accordance with a defined array of the seismic receiver target locations (510) or other operational factors (e.g., timing, geographical setting, physical space, etc.). In some implementation, the master seismic drone (508) may be used to perform heavy computational and communication tasks (e.g., the processing of the data received during the surveillance system procedure, receiving and storing data from other seismic drones (502), providing reliable communication between other seismic drones (502) and the base station (504), or acting as an alternate base station). However, the necessity of using a master seismic drone (508) may be defined by other criteria (e.g., the size of the explored area, the number of seismic drones to be used, the expected distances from base stations or other control points, etc.).

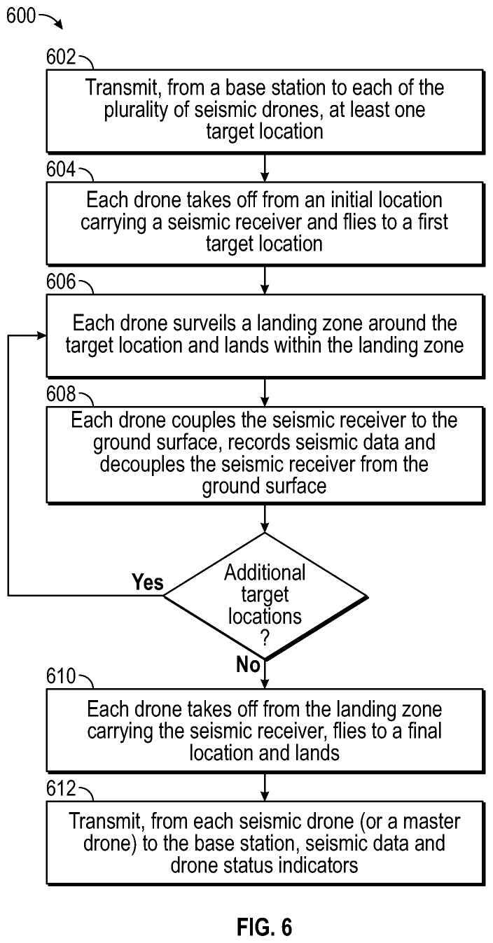

FIG. 6. depicts a flowchart (600), in accordance with one or more embodiments, describing a method of using a seismic drone (502), or a plurality of seismic drones, to deploy seismic receivers (200).

In Step 602, in accordance with one or more embodiments, at least one target location is transmitted from a base station to each of the plurality of seismic drones. The transmission may be done via wi-fi, radio, Bluetooth, etc. The transmission may include multiple target locations for the seismic drone or the target locations for all the seismic drones. The transmission may include other information such as landing zone parameters, seismic recording settings, etc. The transmission may also include quality control diagnostic checks such as battery status, memory status, sensor status, etc. The base station may also have the capability to receive data (e.g., seismic data or sensor data) and store received data to non-transitory computer memory.

In another embodiment the transmission and reception of data from one or more seismic drones may take place between a master seismic drone instead of or in addition to a base station.

In Step 604, in accordance with one or more embodiments, each seismic drone takes off from an initial location carrying a seismic receiver and flies to a first target location. In another embodiment the seismic drone may carry multiple seismic receivers.

In Step 606, in accordance with one or more embodiments, each drone surveils a first landing zone around the first target location and lands within the first landing zone. If the seismic drone surveillance of the landing zone determines the target location to be unsuitable for landing or seismic receiver deployment it may go to an alternate location (defined in the initial transmission, obtained from an updated transmission, or computed by the seismic drone control system).

In Step 608, in accordance with one or more embodiments, each drone couples the seismic receiver to the ground surface, records seismic data, and decouples the seismic receiver from the ground surface. In addition to recording seismic data the seismic drone may record other types of data associated with the seismic drone status (memory capacity, battery capacity, etc.) and seismic receiver diagnostics (e.g., a coupling coefficient, a coupling force, a position, an orientation, or a decoupling force, etc.).

In Step 610, in accordance with one or more embodiments, each seismic drone takes off from the first landing zone carrying the seismic receiver, flies to a final location, and lands. In other embodiments of the method the seismic drone may repeat Steps 602-608 and receive a second target location (or third, fourth, etc.) from the base station or a master drone prior to flying to a final location. Additionally, after the completion of seismic recording (from one or more target locations) the seismic drone may be assigned other tasks (such as seismic data processing, or quality control data processing). These tasks may be conducted simultaneously with other activities such as flying to subsequent target locations or seismic data recording.

In Step 612, in accordance with one or more embodiments, the seismic drone may transmit seismic data and seismic drone status indicators to the base station. The base station may have the capability to receive such data from one or more seismic drones simultaneously and record it to non-transitory computer memory. Additionally, the base station may have the ability to read and display such data through a graphical user interface.

In other embodiments the seismic drones may also transmit data to the base station through a master drone capable of receiving such data from some or all the other drones. Data transmission may occur to the base station or to a master drone after the completion of activities at each target location (e.g., first target location, second target location, third target location) or at the completion of activities at all assigned target locations. The data transmission may occur at scheduled times or occur when drones are within specified proximity to a base station or the master drone.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures. Similarly, any step-plus-function clauses in the claims are intended to cover the acts described here as performing the recited function(s) and equivalents of those acts. It is the express intention of the applicant not to invoke 35 U.S.C. § 112(f) for any limitations of any of the claims herein, except for those in which the claim expressly uses the words “means for” or “step for” together with an associated function.

What is claimed is:

1. A seismic drone, comprising:
a drone, capable of take-off, flight, and landing, wherein the drone comprises:
a positioning device;
a surveillance system;
a telecommunications transceiver;
an electronic control system comprising a microprocessor,
adaptable landing gear; and
seismic receiver deployment system; and
a seismic data recording system.

2. The seismic drone of claim 1, wherein the seismic receiver deployment system comprises:
a seismic receiver;
a coupling system, that detachably couples the seismic receiver to the seismic drone;
an actuator to actively couple the seismic receiver to a ground surface; and
a feedback sensor to measure the coupling.

3. The seismic drone of claim 1, wherein the positioning device comprises a Global Positioning Satellite receiver.

4. The seismic drone of claim 1, wherein the surveillance system comprises a stereoscopic camera, and wherein the microprocessor comprises instructions executable by the microprocessor with functionality for determining a suitable landing point within a landing zone from a photograph obtained by the stereoscopic camera.

5. The seismic drone of claim 1, wherein the telecommunications transceiver is configured to receive a target location from a base station.

6. The seismic drone of claim 1, wherein the adaptable landing gear comprises:
an orientation sensor;
three adjustable legs; and
at least one adjustable joint that attaches a first one of the three adjustable legs to a lower surface of the seismic drone, wherein the adjustable joint is configured to modify an angle of extension of the first one of the three adjustable legs to produce a predetermined orientation of the orientation sensor.

7. The seismic drone of claim 1, wherein the seismic data recording system comprises an analogue-to-digital converter (ADC) that converts an output of the seismic receiver to a digitized seismic trace; and
wherein the telecommunications transceiver is configured to transmit the digitized seismic trace to a base station or a master drone.

8. The seismic drone of claim 6, wherein the microprocessor comprises instructions executable by the microprocessor with functionality for attenuating noise in the digitized seismic trace.

9. A system, comprising:
a plurality of seismic drones, each comprising a seismic receiver; and
a base station in telecommunication with each of the plurality of seismic drones.

10. The system of claim 9, further comprising a master drone in telecommunication with the base station and with the plurality of seismic drones.

11. The system of claim 9, wherein the base station transmits a target location to each seismic drone.

12. The system of claim 9, wherein each of the plurality of seismic drones transmits seismic data to the base station.

13. The system of claim 10, wherein each of the plurality of seismic drones transmits seismic data to the master drone and the master drone transmits the seismic data to the base station.

14. The system of claim 10, wherein each of the plurality of seismic drones transmits seismic data to the master drone and the master drone stores the seismic data in non-transitory computer memory within the master drone.

15. A method of deploying a plurality of seismic drones, each having a seismic receiver and a microprocessor, comprising transmitting, from a base station to each of the plurality of seismic drones, instructions executable by the microprocessor of each seismic drone, the instructions comprising functionality for:
taking off from an initial location carrying the seismic receiver;
flying to a first target location;
surveilling a first landing zone around the first target location;
landing within the first landing zone;
coupling the seismic receiver to a first ground surface;
recording seismic data;
decoupling the seismic receiver from the first ground surface;
taking off from the first landing zone carrying the seismic receiver;
flying to a final location; and
landing at the final location.

16. The method of claim 15, the instructions further having functionality for:
receiving, after taking off from the initial location, a second target location from the base station;
flying to the second target location;
surveilling a second landing zone around the second target location;
landing within the second landing zone;
coupling the seismic receiver to a second ground surface;
recording seismic data;
decoupling the seismic receiver from the second ground surface; and
taking off from the second landing zone carrying the seismic receiver.

17. The method of claim 15, the instructions further having functionality for transmitting the seismic data from a first one of the plurality of seismic drone to the base station, wherein the method further comprises:
receiving the seismic data by the base station; and
storing the seismic data in non-transitory computer memory.

18. The method of claim 15, the instructions further having functionality for transmitting the seismic data from a first one of the plurality of seismic drones to a master drone, wherein the method further comprises:
receiving the seismic data by the master drone; and
storing the seismic data in non-transitory computer memory within the master drone.

19. The method of claim 15, the instructions further having functionality for transmitting seismic drone status indicators from the seismic drone to the base station, wherein the method further comprises:
receiving the status indicators by the base station; and
displaying the status indicators on a graphical user interface.

20. The method of claim 19, wherein the status indicators comprise a coupling coefficient between the seismic receiver and the first ground surface.
